(19) United States
(12) Patent Application Publication
(10) Pub. No.: US 2026/0120141 A1
(43) Pub. Date: Apr. 30, 2026

(54) PRIVACY-FIRST DATA AND AI-DRIVEN PROGRAMMATIC ADVERTISING PLATFORM FOR ENHANCING ADVERTISING CAMPAIGN PERFORMANCE

(71) Applicant: Timothy James Muro, Centerport, NY (US)

(72) Inventor: Timothy James Muro, Centerport, NY (US)

(21) Appl. No.: 18/931,927

(22) Filed: Oct. 30, 2024

(51) Int. Cl. G06Q 30/0242; G06Q 30/018

(52) U.S. Cl. CPC G06Q 30/0244; G06Q 30/018

(57) ABSTRACT

A system for a programmatic advertising platform to enhance advertising campaign performance is disclosed, including a data integration module to receive, from one or more user inputs and a plurality of data stores, data utilized to initialize an advertising campaign. A contact-based targeting module identifies one or more recipients of the advertising campaign. A multi-channel campaign management module optimizes one or more features of the advertising campaign in real-time. A reporting and analytics module reports a status of the advertising campaign and provide the status on a user interface. A compliance management engine monitors one or more compliance parameters associated with the advertising campaign.

### TECHNICAL FIELD

The embodiments disclosed herein generally relate to AI-driven programmatic advertising platforms to aid in campaign performance in business-to-business marketing.

### BACKGROUND

Advertising is an important component of driving business growth and maintaining healthy public relations. Businesses must determine effective ways to communicate with existing and potential customers using various advertisement mediums. Advances in computerized technologies provides business with various methods for digital marketing, lead development, and targeting of potential clients.

Traditional digital advertising has largely relied on third-party cookies to track users across various websites, enabling the collection of data on user behavior and preferences. This data has been used to build user profiles and deliver targeted ads through programmatic platforms. The use of third-party cookies has raised significant privacy issues, as users are often unaware that their browsing data is being tracked and sold to advertisers. This lack of transparency has contributed to a loss of trust in digital advertising practices. With the advent of stringent data privacy regulations such as GDPR and CCPA, the use of third-party cookies has become legally complex and risky. These regulations require explicit user consent for data collection, which has reduced the effectiveness of cookie-based targeting. Major web browsers are phasing out third-party cookies due to privacy concerns, forcing the industry to seek alternative methods for targeting. This transition has highlighted the limitations of traditional cookie-based approaches. Third-party cookies often suffer from inaccuracies due to factors like cookie deletion, browser blocking, and the inability to track users consistently across multiple devices. This results in less effective targeting and inefficient ad spend.

Before advanced data-driven techniques, many digital campaigns relied on broad audience targeting, using basic demographic data such as age, gender, and location. Ads were delivered to large groups fitting these general criteria without the benefit of detailed behavioral insights. Broad audience targeting lacks the precision necessary for reaching specific, relevant audiences within a larger population. This often leads to ads being shown to uninterested users, resulting in lower engagement and conversion rates. Due to its wide-reaching nature, broad targeting often results in a significant portion of the ad spend being wasted on impressions that do not convert. This inefficiency is particularly problematic in B2B marketing, where the goal is to reach specific decision-makers. Without the ability to personalize ads based on detailed data, broad targeting fails to deliver the tailored messaging that modern consumers expect, leading to a disconnect between the ad content and the user's needs.

Contextual targeting involves placing advertisements on websites or pages relevant to the content being viewed by the user. This method does not rely on user-specific data but rather on the context of the content itself. While contextual targeting can be effective in reaching users with relevant content, it lacks the ability to target specific individuals based on their behavior, preferences, or past interactions with a brand. The effectiveness of contextual targeting can vary widely depending on the context, leading to inconsistent ad performance. Without behavioral data, there is no guarantee that the user viewing the content will have any interest in the advertised product or service. Contextual targeting often depends heavily on keyword matching, which can be imprecise and may result in ads being placed in irrelevant or inappropriate contexts, potentially harming brand reputation.

Prior to the rise of programmatic advertising, media buying was a manual process involving direct negotiations between advertisers and publishers. This approach required significant human intervention to manage and optimize campaigns. Manual media buying lacks the automation and efficiency of modern programmatic platforms, requiring significant time and effort to place ads, negotiate deals, and monitor performance. Scaling campaigns manually is challenging, particularly in today's digital landscape, where ads need to be delivered across multiple channels and devices. Manual processes are not equipped to handle the volume and complexity of large-scale digital campaigns. Without access to real-time data and advanced analytics, manual media buying relies on historical data and instinct, often leading to suboptimal decisions and reduced campaign effectiveness.

Some business-to-business advertisers have utilized CRM-based targeting to reach specific contacts within their customer databases. This involves uploading contact lists to ad platforms and targeting these individuals. However, without AI-driven optimization, this approach is relatively static and lacks the ability to adapt in real-time. CRM-based targeting without AI lacks the dynamic adaptability needed to optimize campaigns in real-time. This can lead to missed opportunities and inefficiencies in targeting. Managing CRM-based campaigns without AI requires considerable manual effort to segment audiences, create content, and monitor results, limiting scalability. Without AI, it is difficult to achieve effective personalization based on user behavior or preferences, reducing the relevance and impact of the ads.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to systems and methods for a privacy-first data and AI-driven programmatic advertising platform which is used for enhancing advertising campaign performance between businesses. The system integrates data management with AI-driven optimization strategies to enhance the performance and facilitate the automated analysis of the advertisement campaign.

The system allows for the seamless integration of first-party contact data with AI algorithms, leading to more accurate and effective targeting. The system's platform dynamically optimizes campaigns using AI, adjusting in real-time to maximize ROI and campaign performance. The platform automates complex processes such as audience segmentation, ad placement, and compliance management, reducing the manual effort required and enabling scalable, efficient marketing campaigns. By design, the system is privacy-first, ensuring full compliance with global data privacy regulations.

In some aspects, the system offers features that integrate advanced AI algorithms with first-party data to optimize advertising campaigns in real-time. This includes dynamic budget allocation, ad placement adjustments, and network selection based on continuous performance analysis. The integration of AI with first-party data, is a unique feature that provides businesses with an unprecedented level of control and precision in their campaign optimization efforts. This feature significantly enhances ROI and campaign efficiency.

In some aspects, the system provides multi-channel cross-device advertisement management. In such, the system manages and synchronizes advertising campaigns across multiple digital channels and devices. The system aggregates advertisement inventory from various sources, including social media, display networks, and connected TV, and integrates them into a unified campaign management system. This feature allows for consistent messaging and comprehensive attribution across all touchpoints, improving the effectiveness and reach of B2B marketing campaigns. The optional enhancements further refine this process by enabling real-time optimization and synchronization across channels.

In some aspects, the system provides secure data integration and enrichment that ingests and transforms customer CRM data into a standardized format optimized for analysis. The platform also offers optional data enrichment services that allow businesses to enhance their existing contact data with external information. The combination of secure data handling with the optional AI-driven enrichment process provides a level of data accuracy and security that is unique in the market. This feature ensures that targeting is both precise and compliant with data privacy regulations.

In some aspects, the system provides programmatic account-based marketing (ABM) to enable businesses to deploy highly personalized, programmatic advertising campaigns targeted at specific accounts within their B2B audience. The platform tailors advertisement content based on firmographic data, job title, and other relevant attributes. The ability to combine contact-based targeting with AI-driven personalization in ABM campaigns is a unique feature that maximizes the effectiveness of B2B marketing efforts. This approach ensures that marketing resources are focused on high-value prospects within key accounts.

In some aspects, the system provides automated compliance management for managing and ensuring compliance with data privacy regulations. This involves real-time tracking and management of consent, data processing activities, and audit trails. The automated compliance management module is uniquely integrated with its advertising platform, allowing businesses to handle complex regulatory requirements without compromising on campaign performance. These enhancements further streamline compliance tasks by providing deeper insights and automation.

In some aspects, the system provides the ability to deploy AI models on dedicated, secure servers rather than shared environments. This feature is available as part of the platform's premium offering and allows businesses to customize their AI-driven advertising strategies. The customization and secure deployment of AI models provide businesses with greater control over their data and strategies, ensuring that their AI-driven processes remain proprietary and protected. This feature distinguishes the embodiments from other solutions that rely on shared or open-source AI models.

In some aspects, the system employs fuzzy matching algorithms to refine and clean first-party data, ensuring accurate targeting even when data discrepancies exist, such as misspellings or incomplete information. The use of fuzzy matching in the context of contact-based targeting is a novel approach that significantly improves data accuracy and match rates, leading to more effective advertising campaigns.

In some aspects, the system provides predictive analytics capabilities that use machine learning to forecast campaign performance and user behavior. This feature will allow businesses to proactively adjust their strategies based on anticipated trends. This future feature represents a useful integration of predictive analytics within a programmatic advertising platform, providing businesses with forward-looking insights to optimize their marketing efforts.

In general, a method for utilizing the system for the AI-and data-driven optimization of an advertisement campaign is disclosed. a data integration module integrates a plurality of data receives from one or more user inputs and a plurality of data stores. A contact-based targeting module initializes a plurality of targets as recipients of an advertising campaign. A multi-channel campaign management module generates the advertising campaign, wherein the multi-channel campaign management module optimizes one or more features of the advertising campaign in real-time. A reporting and analytics module reports a status of the advertising campaign and providing the status on a user interface. A compliance management engine monitors one or more compliance parameters associated with the advertising campaigns.

The method described above provides a generalized procedure for generating, distributing and optimizing an advertisement campaign using the components of the system. The AI optimization engine receives the one or more user inputs and the plurality of data to optimize the performance of the advertising campaign via the analysis of one or more of the following: one or more budget allocations, one or more advertisement placements, and one or more network selections. The AI optimization is further configured to modify the advertisement campaign in real-time to optimize a return-on-investment of the advertising campaign.

Additional steps and sub-processes of the method may include various processes for the personalization of a customer journey in programmatic advertising. The may include collecting and analyzing behavioral data from multiple touchpoints using an AI-based customer journey mapping module. Next, campaign content and ad targeting is dynamically adjusted targeting based on real-time behavioral insights to improve personalization and engagement.

In some embodiments, a method for predictive compliance management in programmatic advertising is disclosed. Real-time advertising campaigns are monitored using a machine learning engine trained on historical compliance incidents. Real-time alerts are then generated to the user based on potential regulatory violations and dynamically adjusting campaign parameters to remain compliant with data protection laws.

In some aspects, a method for managing data ownership and consent tracking in programmatic advertising is disclosed wherein user consent and interaction record are stored on a blockchain ledger. Data permissions and consent statuses are then automatically updated via smart contracts, ensuring secure, transparent, and compliant data usage.

In some aspects, a method for automating marketing content generation in programmatic advertising is disclosed, wherein an AI-based content generation engine is used to automatically create, and schedule content based on real-time engagement data and historical performance. Creative assets are then dynamically optimized based on ongoing audience behavior and campaign performance.

In some aspects, a method for generating predictive CRM insights in programmatic advertising is disclosed, wherein CRM data is analyzed with a predictive analytics module to detect churn risks and upsell opportunities. Real-time recommendations for customer engagement are then provided based on historical data analysis and ongoing campaign performance.

In some aspects, a method for adaptive campaign optimization in programmatic advertising is disclosed, wherein external market trends and competitor activity are monitored using an AI optimization engine. Campaign parameters are then dynamically adjusted, including budget and ad placements, to optimize return-on-investment based on real-time external signals.

In some aspects, a method for optimizing ad creatives through AI-powered A/B testing in programmatic advertising is disclosed, wherein creative variations are automatically generated using an AI engine and A/B testing is conducted at scale. Campaign delivery is then automatically adjusted based on A/B test performance to optimize ad engagement.

In some aspects, a method for enforcing ethical AI decision-making in programmatic advertising is disclosed, wherein users are allowed to customize ethical AI guidelines for audience segmentation and decision-making. It is then ensured that AI-driven decisions adhere to defined ethical standards, including data privacy, non-bias, and transparency.

In some aspects, a method for optimizing budget allocation using AI-based predictions is disclosed, wherein past campaign data and ongoing performance metrics are analyzed using an AI-powered budgeting tool. Budget allocations are then automatically adjusted across channels in real-time to maximize overall campaign performance.

In some aspects, a method for managing programmatic advertising through a conversational AI interface is disclosed, wherein voice or text-based commands are received and processed using a natural language processing module to adjust campaign settings, generate reports, and optimize performance in real-time.

In some aspects, a method for optimizing omnichannel attribution in programmatic advertising is disclosed, wherein an AI-based attribution engine is used to dynamically adjust attribution models based on real-time campaign data and customer interactions. Attribution weights and models are then customized according to business-specific sales cycles and audience behaviors.

In some aspects, a method is disclosed for generating real-time performance reports in programmatic advertising. First, an AI-powered reporting engine is used to continuously analyze campaign data and generate predictive insights. The results are then displayed on a customizable dashboard that allows users to track selected KPIs and generate on-demand reports.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the computer system and application program, according to some embodiments;

FIG. 3 illustrates a block diagram of the databases utilized by the application program, according to some embodiments;

FIG. 4 illustrates a flowchart of method for the AI-and data-driven optimization of an advertisement campaign, according to some embodiments;

FIG. 5 illustrates a flowchart of a method for AI-driven optimization of an advertising campaign, according to some embodiments;

FIG. 6 illustrates a flowchart of a method for AI-driven predictive compliance management, according to some embodiments; and FIG. 7 illustrates a method for validating and authenticating data using a blockchain data storage system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and methods for a privacy-first data and AI-driven programmatic advertising platform for enhancing advertising campaign performance. The embodiments are adapted for business-to-business (B2B) marketing and operated by leveraging first-party contact data to create highly targeted advertising campaigns. The embodiments may also include AI-driven enhancements to aid in the optimization of the advertisement campaigns performance. The system integrates secure data management, advanced AI algorithms, and multi-channel advertisement delivery capabilities to maximize marketing effectiveness while ensuring compliance with global privacy and data regulations.

In some embodiments, the system is used by businesses to run precise and effective digital marketing campaigns. The platforms core capabilities provide a foundation for reaching specific decision-makers within target organizations.

The platform automates the buying and placement of ads in real-time, reducing manual intervention and increasing efficiency. This is particularly valuable for large-scale digital campaigns that need to be managed across multiple channels.

The system provides an essential tool for executing ABM strategies, enabling businesses to target key accounts with highly personalized ad content. The optional AI-driven enhancements available to premium users further refine these efforts, increasing the likelihood of conversion.

The system provides businesses with the tools needed to make data-driven decisions about their marketing strategies. The platform's real-time analytics and AI-driven insights (for premium users) allow marketers to adjust their campaigns on the fly, ensuring optimal performance.

The compliance management tools are used to ensure that all marketing activities adhere to global data privacy regulations. The platform's core privacy-first approach, combined with optional AI-driven enhancements, makes it a trusted solution for businesses that prioritize both performance and privacy.

In some embodiments, a system for real-time AI-driven personalization in programmatic advertising is disclosed. An AI-based customer journey mapping module is configured to analyze real-time behavioral data across multiple online and offline touchpoints, providing personalized ad content and experiences. The system adapts campaign elements dynamically, based on collected engagement data, to optimize audience targeting and increase conversions.

In some embodiments, a system for AI-driven predictive compliance management is disclosed, wherein a machine learning engine is trained on historical compliance data and real-time legal updates to detect and predict potential regulatory violations within advertising campaigns. The system provides real-time compliance alerts based on privacy laws, including GDPR, CCPA, and regional data privacy regulations, and continuously updates compliance protocols as legal frameworks evolve.

In some embodiments, a system for ensuring secure data ownership and tracking using blockchain technology is disclosed, wherein a private blockchain ledger records all data transactions, including user consent, data interactions, and updates. The system implements smart contracts to automate consent management, allowing users to update or revoke permissions and ensuring full auditability of data usage.

In some embodiments, a system for automating marketing workflows and content creation is disclosed, wherein an AI-based content generation engine is configured to create ad copy, images, and video scripts based on real-time audience engagement data and historical performance metrics. The system automates campaign workflows, including the scheduling of content and optimization of creative assets based on performance data.

In some embodiments, A system for providing AI-powered CRM data insights is disclosed, wherein a predictive analytics module analyzes CRM data to predict customer lifecycle events, including churn risk, upsell opportunities, and engagement strategies. The system provides real-time recommendations to marketers for improving customer engagement and increasing conversion rates.

In some embodiments, a system for adaptive AI-driven campaign optimization is disclosed, wherein an AI optimization engine dynamically adjusts campaign parameters, such as budget, targeting, and creative elements, based on real-time market trends, seasonal events, and competitor activities. The system autonomously rebalances resources to high-performance channels in response to external factors without requiring manual intervention.

In some embodiments, a system for AI-powered A/B testing at scale is disclosed, wherein an AI engine autonomously generates creative variants and performs A/B testing to determine the best-performing ad creatives based on engagement metrics. The system adjusts live campaigns in real-time based on A/B testing results to maximize audience engagement.

In some embodiments, a system for implementing ethical AI decision-making is disclosed, wherein a customizable ethical AI model layer allows businesses to define ethical guidelines for AI decision-making processes, ensuring compliance with corporate values and avoiding biases in audience segmentation and targeting.

In some embodiments, a system for predictive budgeting and cost optimization is disclosed, wherein an AI-based budgeting tool that analyzes historical campaign data and real-time performance metrics to predict optimal budget allocations and automatically adjusts spending to maximize return on investment.

In some embodiments, a system for interacting with programmatic advertising via a voice-activated or conversational AI interface is disclosed, wherein a natural language processing module allows users to interact with the platform via voice commands or text-based inputs to manage campaigns, request reports, and make real-time adjustments.

In some embodiments, a system for dynamic omnichannel attribution modeling is disclosed, wherein an AI-based attribution engine that dynamically adjusts attribution models across digital and offline channels, allowing users to customize attribution weights based on their business objectives and customer journey stages.

In some embodiments, a system for generating real-time AI-powered reports is disclosed, wherein a customizable dashboard powered by an AI reporting engine that continuously analyzes campaign performance and generates real-time insights based on user-defined KPIs and predictive performance forecasts.

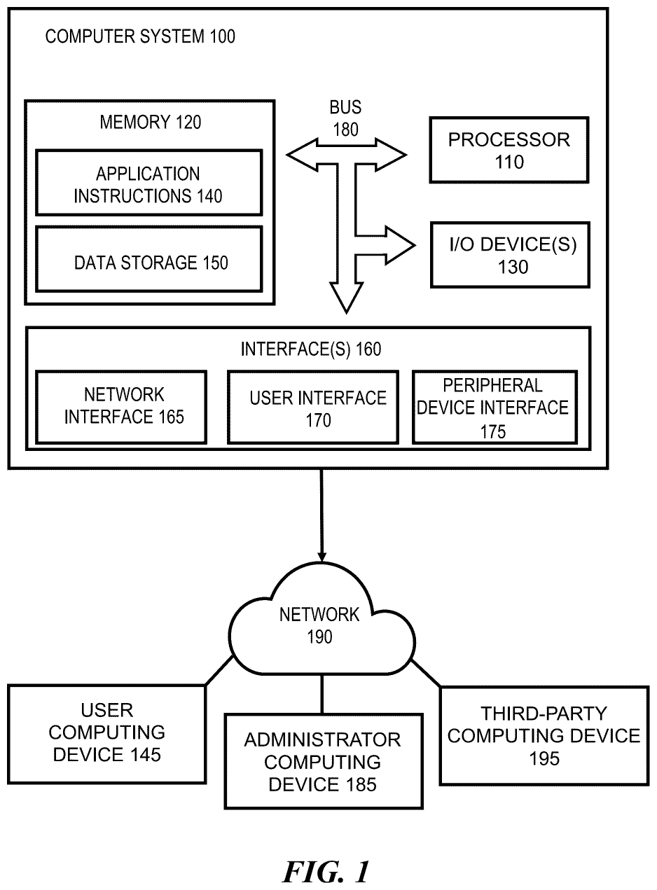

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

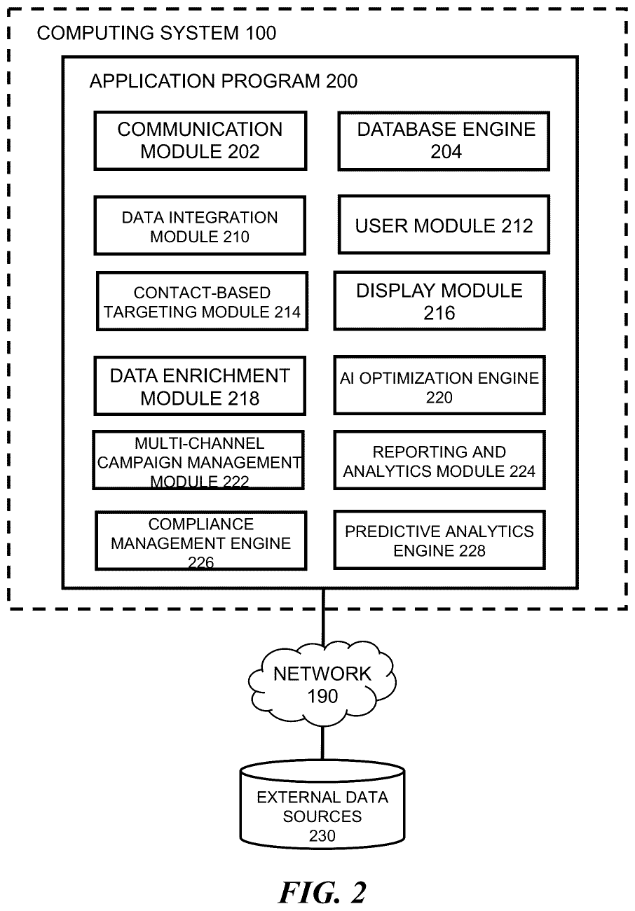

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a data integration module 210, a user module 212, contact-based targeting module 214, a display module 216, a data enrichment module 218, an AI optimization engine 220, a multi-channel campaign management module 222, a reporting and analytics module 224, a compliance management module 226, and a predictive analytics module 228. The network 190 connects the various modules of the application program 200 to a plurality of external data sources 230.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communications module 202 enables the transmission of advertising information as well as the coordination of information throughout the system. For example, the communications module 202 may be in operable communication with the AI optimization engine 220 to extend AI-driven personalization by integrating real-time behavioral data into customer journey mapping. This enables predictive insights for personalized interactions across multiple touchpoints (email, social media, mobile apps, website, etc.) both online and offline. AI algorithms continuously analyze customer behavior, preferences, and engagement data, correlating them with journey stages. The system dynamically adjusts content, offers, and interactions based on current context and historical patterns. The personalization layer can map user personas across touchpoints, tailoring messaging, ad content, and engagement flows to create a seamless omnichannel experience. Predictive analytics anticipate customer needs and trigger automated responses at the most opportune moments in the journey, optimizing for higher conversions. The feature improves engagement and retention by creating hyper-targeted experiences tailored to individual users, based on their real-time behaviors and preferences.

In some embodiments, the communications module 202 may be in communication with the AI optimization engine 220 to provide voice-activated and/or conversational AI within the user interface. This feature introduces a conversational AI interface that allows marketing teams to interact with the platform through voice commands or text-based interactions, simplifying campaign management. The conversational interface is built using natural language processing (NLP) algorithms that understand marketing-specific commands (e.g., “start a new ad campaign,” “adjust my Facebook ad budget”). Users can ask the AI for reports, make changes to campaigns, and request optimization suggestions. The interface supports real-time, two-way interactions and is integrated with both voice-activated devices (like Alexa) and chat-based interfaces. In such, the AI reduces complexity for non-technical users, providing an intuitive and user-friendly interface for campaign management, report generation, and performance analysis.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the data integration module 210 may be in operable communication In some embodiments, the user module 212 facilitates the creation of a user account for the application system. The user module 212 may aid in data ownership and blockchain integrations. This feature integrates blockchain technology to ensure secure, immutable data ownership and tracking, providing transparency for both users and businesses. Each data transaction, whether it's user consent, interaction, or data update is recorded on a private blockchain ledger. This ledger offers tamper-proof auditability, allowing businesses to prove compliance with data regulations and ensuring that users can revoke or modify permissions across all platforms. The system includes smart contracts that automate data usage agreements and user consent management, making it easier for businesses to maintain up-to-date privacy records. In such, this feature enhances trust through transparency, secures user data against tampering, and simplifies data management across distributed systems while maintaining compliance.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the display module 216, in communication with the data integration module 210 automates marketing workflows and content creation based on real-time audience engagement metrics and campaign performance history. To accomplish this, the AI analyzes engagement patterns (e.g., open rates, click-through rates, bounce rates) and automatically generates relevant content such as ad copy, social media posts, video scripts, and email templates. Content generation is tailored to audience segments and campaign goals, with machine learning models continuously refining suggestions based on A/B testing results and engagement data. Workflow automation features include the scheduling of posts and automated adjustments of creative assets based on performance. In such, this feature reduces manual workload by automating content creation and streamlining campaign management, improving efficiency and ensuring data-driven decisions.

In some embodiments, the data enrichment module 218 is in operable communication with the application program to enrich data received form external data sources 230. The data enrichment module 218 may work with the AI optimization engine 220 to autonomously enrich data.

In some embodiments, the AI optimization engine 220 is operable to enhance and optimize various features of the system. In one example, the AI optimization engine is used for the dynamic adaptation of campaign strategies based on external factors such as market trends, seasonal events, and competitor activities. AI models continuously monitor market signals, including competitor campaigns, macroeconomic data, and social trends. The system adjusts campaign parameters such as ad spend, targeting criteria, and creative elements in real-time based on these insights. This approach allows campaigns to respond to external factors without requiring manual intervention, shifting priorities and rebalancing efforts toward high-performance channels or target audiences. In such, the AI optimization engine 220 increases agility in marketing campaigns, allowing businesses to capitalize on real-time market shifts and competitor actions, thereby improving overall performance.

In some embodiments, the multi-channel campaign management module 222 is operable to manage multiple campaigns autonomously through the integration with the AI optimization engine 210.

In some embodiments, the multi-channel campaign management module 222 provides dynamic omnichannel attribution modeling to allow businesses to adjust attribution models in real-time, based on their unique sales cycles and customer touchpoints. The system integrates attribution models across digital and offline touchpoints, offering options for first-click, last-click, time-decay, and custom multi-touch attribution models. AI analyzes user interactions across all channels and adjusts attribution weights dynamically to reflect changes in user behavior or campaign goals. The system supports real-time adjustments and provides insights into which channels are most effective at each stage of the buyer journey. In such, this feature increases precision in tracking the effectiveness of each marketing channel, enabling marketers to accurately measure ROI and optimize spending.

In some embodiments, the reporting and analytics module 224 is in operable communication with the AI optimization engine 220 and display module 210 to provide AI-powered analysis of CRM data to provide predictive insights on customer lifecycle events, such as churn, upsell opportunities, and engagement strategies. To accomplish this, machine learning models analyze customer interactions, transaction histories, and support tickets, identifying patterns that signal high churn risk or opportunities for cross-sell or upsell campaigns. Predictive algorithms also provide suggested actions to improve customer retention and maximize lifetime value. Insights are visualized in real-time dashboards that offer campaign managers actionable recommendations. This feature enables marketers to make data-driven decisions on how to engage customers at critical lifecycle stages, ultimately increasing customer retention and revenue growth.

In some embodiments, the reporting and analytics module 224 may utilize the functionalities of the AI optimization engine 220 to provide AI-based predictive budgeting and cost optimization. This features leverages AI to predict the most effective budgeting allocations for campaigns and adjusts budget distribution based on real-time performance metrics. To accomplish this, predictive models analyze historical campaign data, market conditions, and ongoing campaign performance to forecast optimal budget allocations across channels and campaigns. The system dynamically reallocates resources to the best-performing ads and underperforming segments are minimized. It also provides insights into future spending patterns and expected ROI, helping businesses optimize budgets for maximum efficiency. In such, this feature maximizes ROI by continuously optimizing budget allocation, allowing businesses to spend smarter and adjust to real-time campaign performance.

In some embodiments, the reporting and analytics module 224 may utilize the functionalities of the AI optimization engine 220 to provide AI-powered creative A/B testing at scale. This feature automates the process of A/B testing for creative assets at scale, generating and testing variations to optimize for user engagement and conversions. To accomplish this, AI algorithms generate multiple creative variants (e.g., different headlines, images, CTAs) based on a predefined set of content elements. These variants are then deployed across the target audience with real-time A/B testing to assess their effectiveness. The system automatically adjusts campaign delivery based on test results, favoring the best-performing variants. Additionally, the AI models learn from each test, refining creative suggestions for future campaigns. In such, this feature streamlines the creative testing process and eliminates guesswork, leading to more effective campaigns with optimal creative assets chosen through data-backed decisions.

In some embodiments, the compliance management module 226 is operable to ensure compliance with marketing data and privacy data regulations by providing predictive compliance management. This feature uses AI to predict potential compliance risks in digital advertising and data management processes. It compares real-time data processing activities with regulatory frameworks such as GDPR, CCPA, and other regional privacy laws. The system leverages machine learning models trained on historical compliance incidents, legal updates, and company-specific activities. It scans active campaigns and customer data processing pipelines for potential violations (e.g., improper data usage, missing consent records). Real-time alerts are generated if any regulatory misalignment is detected. The system also auto-updates as privacy laws evolve, ensuring compliance without manual intervention. In such, this feature proactively mitigates risk of compliance violations, avoiding fines and reputational damage, while also reducing manual compliance management overhead.

In some embodiments, the compliance management module 226 is in operable communication with an ethical AI model to allow businesses to customize ethical guidelines for AI-driven decision-making, ensuring that AI-powered recommendations and optimizations adhere to specific ethical standards. To accomplish this, the system includes an “Ethical AI” module that lets users define parameters for AI decision-making, such as avoiding bias in audience segmentation, ensuring transparent data use, and prioritizing responsible data collection. This module integrates with existing machine learning workflows, enforcing ethical guidelines at each stage of AI processing, from data collection to content delivery. Users can also review and audit AI decisions to ensure compliance with company-specific ethical standards. This feature establishes trust and ensures that AI processes align with corporate values and industry ethics, while providing transparency and accountability in AI-driven marketing.

In some embodiments, the predictive analytics engine 228 and reporting and analytics module 224 provide customizable reporting dashboards powered by AI, offering real-time insights into key campaign performance metrics. AI models continuously analyze campaign data, generating real-time reports with detailed insights into KPIs, engagement trends, and predictive performance forecasts. Users can customize the dashboard to display the most relevant data points for their campaigns, and AI recommends key metrics to focus on based on business goals. Dashboards also provide predictive insights, alerting users to potential issues or opportunities before they arise. This feature offers real-time, data-driven insights that enable businesses to optimize campaigns on-the-fly and make informed decisions based on live performance metrics.

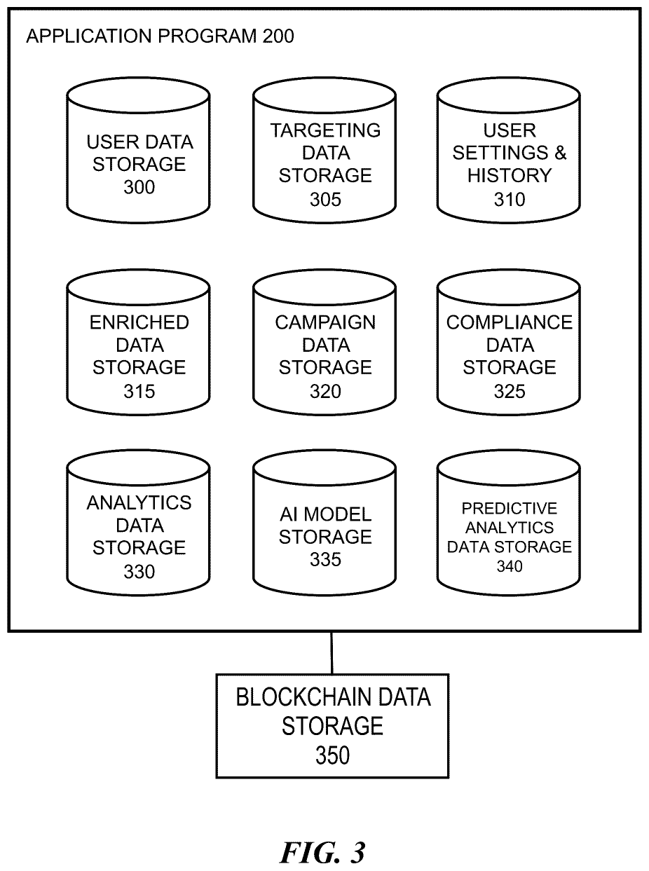

FIG. 3 illustrates a block diagram of the databases in communication with the application program including the user data storage 300, targeting data storage 305, user settings and history 310, enriched data storage 315, campaign data storage 320, compliance data storage 325, analytics data storage 330, AI model storage 335, and predictive analytics data storage 340. The application data program is also in communication with a blockchain data storage 350.

In some embodiments, the user data storage 300 stores user data which may be used to generate customized and personalized information. The user data storage 300 may include various user's preferences, personal information, demographic information, etc.

In some embodiments, the targeting data storage 305 stores data utilized to dynamically target or otherwise engage with others to optimize audience targeting, increase conversions and otherwise collect engagement data. This may be performed in real-time based on behavioral insights to improve personalization and engagement.

In some embodiments, the user settings and history 310 stores user settings which have been input by the user. This may also include user history information which can be used for the generation of future campaigns.

In some embodiments, the enriched data storage 315 stores data which has been generated by the system's data enrichment module.

In some embodiments, the campaign data storage 320 stores campaign data from previous and/or in-progress campaigns which can be used for analytics, reporting, etc.

In some embodiments, the compliance data storage 325 stores compliance data including privacy compliance regulations, data compliance regulations, and/or compliance information associated with specific agencies, governments, and/or jurisdictions.

In some embodiments, the analytics data storage 330 stores data generated by the reporting and analytics module to enable the transmission of analytics data to the user, administrator, etc. This may also be used in conjunction with the predictive analytics data storage 340.

In some embodiments, the AI model storage 335 stores information associated with the AI models utilized by the system. The AI model data may be used to inform future iterations of AI engines, ML engines, NLP engines and the like.

In some embodiments, the blockchain data storage 350 provides a means of ensuring secure data ownership and tracking using blockchain technology. The blockchain ledger 350 utilized by the blockchain data storage 350 records data transactions (including user consent, data interactions, and updates to data). The system may implement smart contracts to automate consent management, allowing users to update or revoke permissions and ensure full auditability of data usage.

In some embodiments, the blockchain data storage 350 may be used to authenticate or validate interactions with the advertising campaign. For example, the blockchain data storage 350 may be used to validate that each click (i.e., interaction) with the advertising campaign is performed by a human, rather than an automated bot system, etc. This promotes trust by ensuring that clicks are received and billed for only when a human performs them, thus reducing costs to the owner of the advertising campaign, and thus increasing ROI of the advertising campaign.

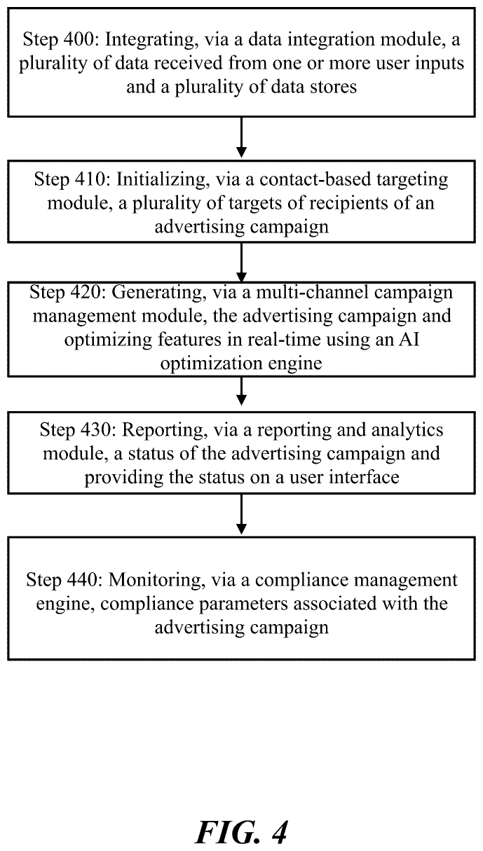

FIG. 4 illustrates a flowchart of a method for the AI-and data-driven optimization of an advertisement campaign. In step 400, a data integration module integrates a plurality of data receives from one or more user inputs and a plurality of data stores. In step 410, a contact-based targeting module initializes a plurality of targets as recipients of an advertising campaign. In step 420, a multi-channel campaign management module generates the advertising campaign, wherein the multi-channel campaign management module optimizes one or more features of the advertising campaign in real-time. In step 430, a reporting and analytics module reports a status of the advertising campaign and providing the status on a user interface. In step 440, a compliance management engine monitors one or more compliance parameters associated with the advertising campaigns.

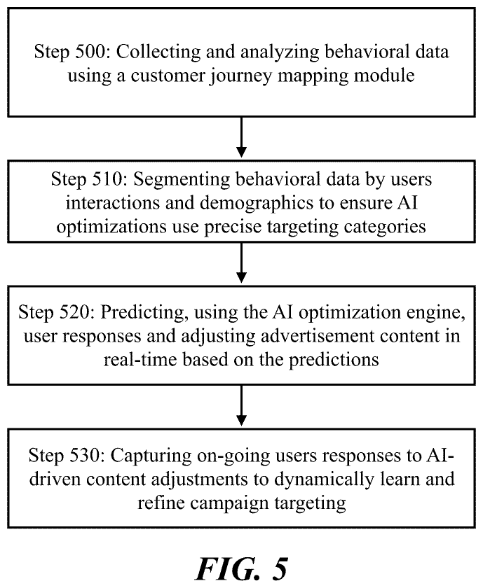

FIG. 5 illustrates a flowchart of a method for AI-driven optimization of an advertising campaign. In step 500, an AI optimization engine collects and analyzes behavior data from a plurality of data sources using a customer journey mapping module. In step 510, the behavioral data is segmented by user interactions and demographics to ensure the AI optimizations use precise targeting categories. This supports blockchain validation by confirmation each click interactions authenticity and relevancy prior to its influence on advertisement delivery. In step 520, the AI optimization engine predicts user responses and adjusts the advertisement campaign content in real-time based on the predictions. In step 530, the AI optimization engine dynamically adjusts campaign content and advertisement targeting based on real-time data (e.g., behavior insights, cost analytics, profit analytics, etc.) to improve personalization and engagement.

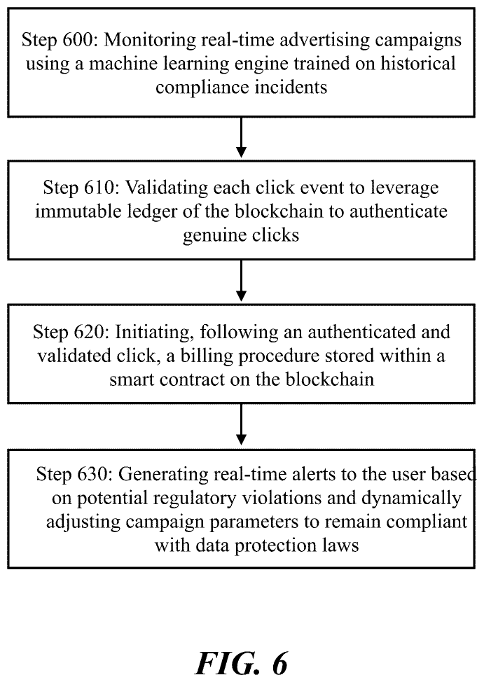

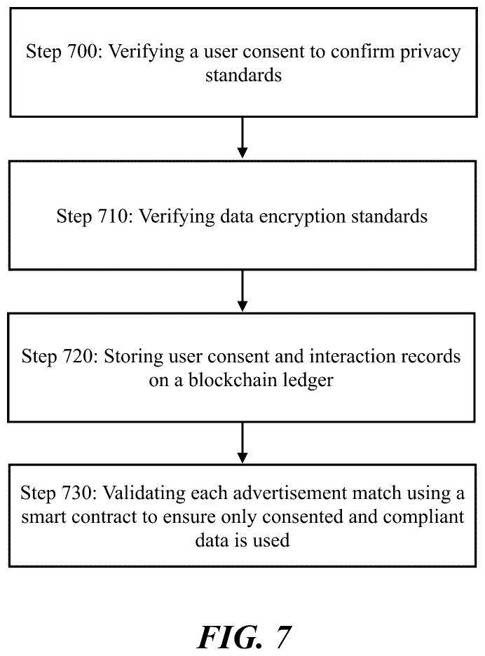

FIG. 6 illustrates a flowchart of a method for AI-driven predictive compliance management. In step 600, advertising campaigns are monitored in real-time using a machine learning engine trained on historical compliance incidents. In step 610, each click is validated to leverage the immutable ledger of the blockchain to authenticate each click (thus determining each click was performed by a genuine user. In step 620, a billing procedure is initiated following the authenticated and validated clock. The billing information is stored by a smart contract within the blockchain. In step 630, alerts are generated in real-time to the user based on potential regulatory violations and dynamically adjusting campaign parameters to remain compliant with data protections laws. The process described and illustrated in FIG. 6 confirms legitimate clicks by authenticated users to prevent fraudulent activity from impacting costs to the business.

FIG. 7 illustrates a flowchart of a method for validating and authenticating data using a blockchain data storage system. In step 700, a user consent is verified to confirm privacy standards and in step 710 data encryption standards are verified. In step 720, user consent and interaction records are stored on a blockchain data storage ledger. In step 730, each advertisement match is validated using a smart contract to ensure only consented and compliant data is used. Data permissions and consent statuses are automatically updated via smart contracts to ensure secure, transparent and compliant data usage. For example, this process may be used to validate interactions and monetary transactions executed by nodes to ensure that a click performed on the advertising campaign was in-fact performed by a validated and authenticated user.

The methods described above provides a generalized procedure for generating, distributing and optimizing an advertisement campaign using the components of the system. The AI optimization engine receives the one or more user inputs and the plurality of data to optimize the performance of the advertising campaign via the analysis of one or more of the following: one or more budget allocations, one or more advertisement placements, and one or more network selections. The AI optimization is further configured to modify the advertisement campaign in real-time to optimize a return-on-investment of the advertising campaign.

Additional steps and sub-processes of the method may include various processes for the personalization of a customer journey in programmatic advertising. The may include collecting and analyzing behavioral data from multiple touchpoints using an AI-based customer journey mapping module. Next, campaign content and ad targeting is dynamically adjusted targeting based on real-time behavioral insights to improve personalization and engagement.

In some embodiments, a method for predictive compliance management in programmatic advertising is disclosed. Real-time advertising campaigns are monitored using a machine learning engine trained on historical compliance incidents. Real-time alerts are then generated to the user based on potential regulatory violations and dynamically adjusting campaign parameters to remain compliant with data protection laws.

In some embodiments, a method for managing data ownership and consent tracking in programmatic advertising is disclosed wherein user consent and interaction record are stored on a blockchain ledger. Data permissions and consent statuses are then automatically updated via smart contracts, ensuring secure, transparent, and compliant data usage.

In some embodiments, a method for automating marketing content generation in programmatic advertising is disclosed, wherein an AI-based content generation engine is used to automatically create, and schedule content based on real-time engagement data and historical performance. Creative assets are then dynamically optimized based on ongoing audience behavior and campaign performance.

In some embodiments, a method for generating predictive CRM insights in programmatic advertising is disclosed, wherein CRM data is analyzed with a predictive analytics module to detect churn risks and upsell opportunities. Real-time recommendations for customer engagement are then provided based on historical data analysis and ongoing campaign performance.

In some embodiments, a method for adaptive campaign optimization in programmatic advertising is disclosed, wherein external market trends and competitor activity are monitored using an AI optimization engine. Campaign parameters are then dynamically adjusted, including budget and ad placements, to optimize return-on-investment based on real-time external signals.

In some embodiments, a method for optimizing ad creatives through AI-powered A/B testing in programmatic advertising is disclosed, wherein creative variations are automatically generated using an AI engine and A/B testing is conducted at scale. Campaign delivery is then automatically adjusted based on A/B test performance to optimize ad engagement.

In some embodiments, a method for enforcing ethical AI decision-making in programmatic advertising is disclosed, wherein users are allowed to customize ethical AI guidelines for audience segmentation and decision-making. It is then ensured that AI-driven decisions adhere to defined ethical standards, including data privacy, non-bias, and transparency.

In some embodiments, a method for optimizing budget allocation using AI-based predictions is disclosed, wherein past campaign data and ongoing performance metrics are analyzed using an AI-powered budgeting tool. Budget allocations are then automatically adjusted across channels in real-time to maximize overall campaign performance.

In some embodiments, a method for managing programmatic advertising through a conversational AI interface is disclosed, wherein voice or text-based commands are received and processed using a natural language processing module to adjust campaign settings, generate reports, and optimize performance in real-time.

In some embodiments, a method for optimizing omnichannel attribution in programmatic advertising is disclosed, wherein an AI-based attribution engine is used to dynamically adjust attribution models based on real-time campaign data and customer interactions. Attribution weights and models are then customized according to business-specific sales cycles and audience behaviors.

In some embodiments, a method is disclosed for generating real-time performance reports in programmatic advertising. First, an AI-powered reporting engine is used to continuously analyze campaign data and generate predictive insights. The results are then displayed on a customizable dashboard that allows users to track selected KPIs and generate on-demand reports.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for a programmatic advertising platform to enhance advertising campaign performance, the system comprising:
a data integration module receive, from one or more user inputs and a plurality of data stores, data utilized to initialize an advertising campaign;
a contact-based targeting module to identify one or more recipients of the advertising campaign;
a multi-channel campaign management module to optimize one or more features of the advertising campaign in real-time;
a reporting and analytics module to report a status of the advertising campaign and provide the status on a user interface; and
a compliance management engine to monitor one or more compliance parameters associated with the advertising campaign;
an artificial intelligence optimization engine operated by the application program, the artificial intelligence engine to analyze real-time data received from the data integration module to provide predictive compliance management and predictive analytics to dynamically update the advertising campaign; and
a blockchain-enabled data storage to record a plurality of transactions and to record validate one or more interactions with the advertising campaign.

2. The system of claim 1, wherein the plurality of data stores includes one or more of the following: a user data storage; a targeting data storage; a user settings and history database; an enriched data storage; a campaign data storage; a compliance data storage; an analytics data storage; an AI model storage; and a predictive analytics data storage, wherein one or more of the plurality of data stores utilize a blockchain.

3. The system of claim 1, wherein the AI optimization engine to receive the one or more user inputs and the plurality of data to optimize the performance of the advertising campaign via the analysis of one or more of the following: one or more budget allocations; one or more advertisement placements; and one or more network selections.

4. The system of claim 3, wherein the AI optimization engine is operable to maximize the return-on-investment of the advertising campaign using performance data received from the reporting and analytics module.

5. The system of claim 1, wherein the contact-based targeting module utilizes privacy-first contact-based targeting to generate a list of targets using one or more hashed email addresses and names via the mapping of customer CRM data.

6. The system of claim 1, wherein the compliance management engine securely integrates and enriches the plurality of data to generate one or more insights related to consent management and audit trails.

7. The system of claim 6, wherein a matching algorithm is employed to refine and clean the plurality of data to ensure accurate matches and to enhance a plurality of contact data and enable precise targeting of the one or more targets of the advertisement campaign.

8. A method for enhancing advertising campaign performance, the method comprising the steps of:
integrating, via a data integration module, a plurality of data receive from one or more user inputs and a plurality of data stores;
initializing, via a contact-based targeting module, a plurality of targets as recipients of an advertising campaign;
generating, via a multi-channel campaign management module, the advertising campaign, wherein the multi-channel campaign management module optimizes one or more features of the advertising campaign in real-time;
reporting, via a reporting and analytics module, a status of the advertising campaign and providing the status on a user interface; and
monitoring, via a compliance management engine, one or more compliance parameters associated with the advertising campaign;
optimizing, via an artificial intelligence optimization engine, the advertising campaign using the plurality of data received from the data integration module and one or more compliance parameters, and to dynamically update the advertising campaign in real-time; and
validating, via a blockchain-enabled data storage, each of a plurality of interactions with the advertising campaign.

9. The method of claim 8, wherein the plurality of data stores includes one or more of the following: a user data storage; a targeting data storage; a user settings and history database; an enriched data storage; a campaign data storage; a compliance data storage; an analytics data storage; an AI model storage; and a predictive analytics data storage.

10. The method of claim 8, further comprising an AI optimization engine to receive the one or more user inputs and the plurality of data to optimize the performance of the advertising campaign via the analysis of one or more of the following: one or more budget allocations; one or more advertisement placements; and one or more network selections.

11. The method of claim 8, wherein the AI optimization engine is operable to maximize the return-on-investment of the advertising campaign using performance data received from the reporting and analytics module.

12. The method of claim 8, wherein the contact-based targeting module utilizes privacy-first contact-based targeting to generate a list of targets using one or more hashed email addresses and names via the mapping of customer CRM data.

13. The method of claim 8, wherein the compliance management engine securely integrates and enriches the plurality of data to generate one or more insights related to consent management and audit trails.

14. The method of claim 8, wherein a matching algorithm is employed to refine and clean the plurality of data to ensure accurate matches and to enhance a plurality of contact data and enable precise targeting of the one or more targets of the advertisement campaign.

15. A system for the AI-driven enhancement of advertising campaign performance, the system comprising:
at least one user computing device in operable communication with a user network;
an application server in operable communication with the user network, the application server configured to host an application program for enabling the AI-driven enhancement of an advertising campaign, the application program in operable communication with a processor to perform the steps of:
integrating, via a data integration module, a plurality of data receives from one or more user inputs and a plurality of data stores;
initializing, via a contact-based targeting module, a plurality of targets as recipients of an advertising campaign;
generating, via a multi-channel campaign management module, the advertising campaign, wherein the multi-channel campaign management module optimizes one or more features of the advertising campaign in real-time;
reporting, via a reporting and analytics module, a status of the advertising campaign and providing the status on a user interface;
monitoring, via a compliance management engine, one or more compliance parameters associated with the advertising campaign;
optimizing, via an artificial intelligence optimization engine, the advertising campaign using the plurality of data received from the data integration module and one or more compliance parameters, and to dynamically update the advertising campaign in real-time; and
validating, via a blockchain-enabled data storage, each of a plurality of interactions with the advertising campaign,
wherein the AI optimization engine receives the one or more user inputs and the plurality of data to optimize the performance of the advertising campaign via the analysis of one or more of the following: one or more budget allocations, one or more advertisement placements, and one or more network selections, and wherein the AI optimization is configured to modify the advertisement campaign in real-time to optimize a return-on-investment of the advertising campaign.

16. The system of claim 15, wherein the plurality of data stores includes one or more of the following: a user data storage; a targeting data storage; a user settings and history database; an enriched data storage; a campaign data storage; a compliance data storage; an analytics data storage; an AI model storage; and a predictive analytics data storage.

17. The system of claim 15, wherein the AI optimization engine is operable to maximize the return-on-investment of the advertising campaign using performance data received from the reporting and analytics module.

18. The system of claim 15, wherein the contact-based targeting module utilizes privacy-first contact-based targeting to generate a list of targets using one or more hashed email addresses and names via the mapping of customer CRM data.

19. The system of claim 15, wherein the compliance management engine securely integrates and enriches the plurality of data to generate one or more insights related to consent management and audit trails.

20. The system of claim 15, wherein a matching algorithm is employed to refine and clean the plurality of data to ensure accurate matches and to enhance a plurality of contact data and enable precise targeting of the one or more targets of the advertisement campaign.
